(19) United States
(12) Patent Application Publication
(10) Pub. No.: US 2016/0137037 A1
(43) Pub. Date: May 19, 2016

(54) SHADING DEVICE AND ASSEMBLING METHOD THEREOF

(71) Applicant: HAYASHI TELEMPU Co., Ltd., Nagoya-shi (JP)

(72) Inventors: Keisuke WATANABE, Aichi (JP); Toshiya NISHIURA, Aichi (JP); Yoshihiro TSUCHIMOTO, Aichi (JP)

(73) Assignee: HAYASHI TELEMPU Co., Ltd.

(21) Appl. No.: 15/005,006

(22) Filed: Jan. 25, 2016

Related U.S. Application Data
(63) Continuation of application No. PCT/JP2014/065084, filed on Jun. 6, 2014.

(30) Foreign Application Priority Data
Aug. 26, 2013 (JP) 2013-174195

(51) Int. Cl. B60J 1/20

(52) U.S. Cl. CPC B60J 1/2038; B60J 1/2086; B60J 1/2063

(57) ABSTRACT

The present invention discloses a shading device includes a screen, a shaft portion, a case including a wall portion having a hole so that an end portion of the shaft portion is inserted into the hole while a first clearance is formed, the case including a side face portion having an opening so that the shaft portion is entered in a housing position from a direction different from an axial direction of the shaft portion when the shaft portion is located at the housing position, a biasing mechanism that biases the screen toward the shaft portion, and a shaft support portion that is inserted into the first clearance formed between the hole of the wall portion and the end portion of the shaft portion to prevent the end portion of the shaft portion from moving in the direction different from the axial direction.

### CROSS-REFERENCES TO RELATED APPLICATIONS

This application claims the benefit of priority and is a Continuation application of the prior International Patent Application No. PCT/JP2014/065084, with an international filing date of Jun. 6, 2014, which designated the United States, and is related to the Japanese Patent Application No. 2013-174195, filed Aug. 26, 2013, the entire disclosures of all applications are expressly incorporated by reference in their entirety herein.

### BACKGROUND OF THE INVENTION

1. Field of the Invention

The present invention relates to a shading device installed in a vehicle cabin of an automobile, for example, and an assembling method thereof.

2. Description of Related Art

On the vehicle door or the like, a sunshade device is provided for blocking sunlight for the purpose of preventing dazzling and for protecting privacy. In the sunshade device for the vehicle door, in many cases, a shading screen is wound and housed inside a door body when not in use. When in use, the screen is drawn out upward along a window glass and the screen is held at a use position to cover the window glass by, for example, engaging a hook of a tip of the screen with an engagement portion of the door side.

In a sunshade housing case of a lining for vehicle disclosed in Japanese Unexamined Patent Application Publication No. H11-245663, an opening to load/unload the sunshade is smaller than an outer diameter of a winding shaft, and walls are not provided at both ends. When attaching components to the lining, a winding drum and a winding shaft are inserted from one end side of the housing case while the sunshade is taken out of the opening, and then caps are attached to both ends of the housing case to fix the housing case and the caps with the lining.

In a vehicle door trim disclosed in Japanese Unexamined Patent Application Publication No. 2003-300415, a recess is formed on a door trim body, and the recess of the door trim body is covered with a shade cover in a state that a rolled shade of a sunshade unit is preliminarily attached with the shade cover.

Both ends of a shaft of the rolled shade are rotatably supported by a pair of support arms formed at a reverse side of the shade cover.
On the support arms, a hole is provided, the hole having an inner diameter consistent with an outer diameter of the shaft of the rolled shade.
A method of attaching the shaft of the rolled shade with the support arms is not disclosed.

### BRIEF SUMMARY OF THE INVENTION

In order to form the lining for vehicle disclosed in Japanese Unexamined Patent Application Publication No. H11-245663, the sunshade should be taken out of the narrow opening and, while keeping this state, the winding drum and the winding shaft should be inserted from one end side of the housing case, and then the caps should be attached on both ends of the housing case. Therefore, it is difficult to insert a hand into the housing case and difficult to see the winding shaft and other components inserted into the housing case. Thus, workability to let the end portions of the winding shaft be supported on the caps is not good.

If the hole having an inner diameter consistent with an outer diameter of the shaft of the rolled shade is formed on the support arm as shown in Japanese Unexamined Patent Application Publication No. 2003-300415, the shaft of the rolled shade cannot be inserted into the hole of the support arm while the rolled shade is inclined against the shade cover. Therefore, workability is not good when inserting the shaft of the rolled shade into the hole of the support arm to attach the rolled shade with the shade cover.

Note that the above described problems also occur in the shading devices other than the sunshade device. For example, the problems occur in a tonneau cover device.

The present invention discloses a technology to improve the workability when assembling the shading device.

One aspect of the present invention provides a shading device, comprising:

a screen;

a shaft portion to which one end of the screen is fastened;

a case from which the screen can be drawn out, the case including a wall portion having a hole so that an end portion of the shaft portion is inserted into the hole while a first clearance is formed, the case including a side face portion having an opening so that the shaft portion is entered in a housing position from a direction, the direction being different from an axial direction of the shaft portion when the shaft portion is located at the housing position;

a biasing mechanism that biases the screen toward the shaft portion; and

a shaft support portion that is inserted into the first clearance formed between the hole of the wall portion and the end portion of the shaft portion to prevent the end portion of the shaft portion from moving in the direction different from the axial direction.

Another aspect of the present invention provides a method of assembling a shading device, the shading device including a screen, a shaft portion to which one end of the screen is fastened, a case from which the screen can be drawn out, and a biasing mechanism that biases the screen toward the shaft portion, the method comprising:

forming a wall portion on the case, the wall portion having a hole so that an end portion of the shaft portion is inserted into the hole while a first clearance is formed;

forming a side face portion on the case, the side face portion having an opening so that the shaft portion is entered in a housing position from a direction, the direction being different from an axial direction of the shaft portion when the shaft portion is located at the housing position;

entering the end portion of the shaft portion in the opening to insert the shaft portion into the hole of the wall portion,

positioning the shaft portion at the housing position, and

inserting a shaft support portion into the clearance formed between the hole of the wall portion and the end portion of the shaft portion to prevent the end portion of the shaft portion from moving in the direction different from the axial direction.

The shaft portion can be entered in the housing position from the opening formed on the side face portion of the case. The end portion of the shaft portion is inserted into the hole formed on the wall portion of the case so that the clearance is formed. Therefore, while the shaft portion is inclined, the shaft portion can be entered in the opening and the end portion of the shaft portion can be inserted into the hole of the wall portion, for example. When the shaft support portion is inserted into the clearance formed between the hole of the wall portion and the end portion of the shaft portion, the end portion of the shaft portion is prevented from moving in the direction different from the axial direction of the shaft portion.

Here, the screen can be any screen as long as it blocks at least a part of transmitted light. The screen is not limited to the purpose of sun shading.

The shaft portion includes a cylindrical member, a rod-like member and the like.

The shaft portion can be a single member or a combination of a plurality of members. The shaft portion can be a member rotated around the axial center or a member not rotated. In addition, the shaft portion can include both a rotating part and a non-rotating part. For example, the end portion can be the non-rotating part while other parts are the rotating part.

The hole of the wall portion can be a through hole or a recess not passing through the wall portion.

The side face portion of the wall portion means a portion located around the shaft portion when the shaft portion is in the housing position. The side face portion includes a portion arranged in a vertical direction and a portion arranged in a longitudinal direction.

The biasing mechanism includes a spring, a rubber and the like. The definition “the screen is biased toward the shaft portion” includes concepts “the shaft portion is biased in the winding direction of the screen” and “the shaft portion is biased in the direction of folding the screen,” for example.

The shaft support portion can be an independent member or can be connected with other members such as the case. The shaft support portion can be a member or a portion that separates the end portion of the shaft portion from the wall portion. The shaft support portion can be a member or a portion that makes the end portion of the shaft portion be in contact with the wall portion. Furthermore, the shaft support portion can be inserted into the hole from outside the wall portion or from inside the wall portion.

The definition “the end portion of the shaft portion is prevented from moving” not only means “movement of the end portion of the shaft portion is completely prevented” but also means “movement of the end portion of the shaft portion is reduced.”

### BRIEF DESCRIPTION OF THE DRAWINGS

FIG. 1 is a perspective view showing an example of a side door to which a shading device 1 is assembled, seen from a vehicle cabin C1 side.

FIG. 2 is an exploded perspective view showing an example of a configuration of the shading device 1.

FIG. 3 is an exploded perspective view showing an example of a configuration of the shading device 1 from another angle.

FIG. 4 is an exploded perspective view showing an example of a configuration of a biasing mechanism 5.

FIG. 5 is an exploded perspective view showing an example of a main part of the shading device 1.

FIGS. 6A to 6C are perspective views showing an example of a shaft support portion 6.

FIGS. 7A and 7B are cross-sectional views showing an example of a main part of the shading device 1.

FIGS. 8A to 8C are drawings schematically showing an example of an assembling method of the shading device 1.

FIGS. 9A to 9C are drawings schematically showing an example of a main part of another shading device 1.

FIGS. 10A to 10C are drawings schematically showing an example of a main part of another shading device 1.

FIGS. 11A to 11C are drawings schematically showing an example of a main part of another shading device 1.

### DETAILED DESCRIPTION OF THE INVENTION

An embodiment of the present invention will be described below. Of course, the below-described embodiment merely exemplifies the present invention. All features disclosed in the embodiment are not necessarily required to solve the problem of the present invention.

### (1) OUTLINE OF TECHNOLOGY

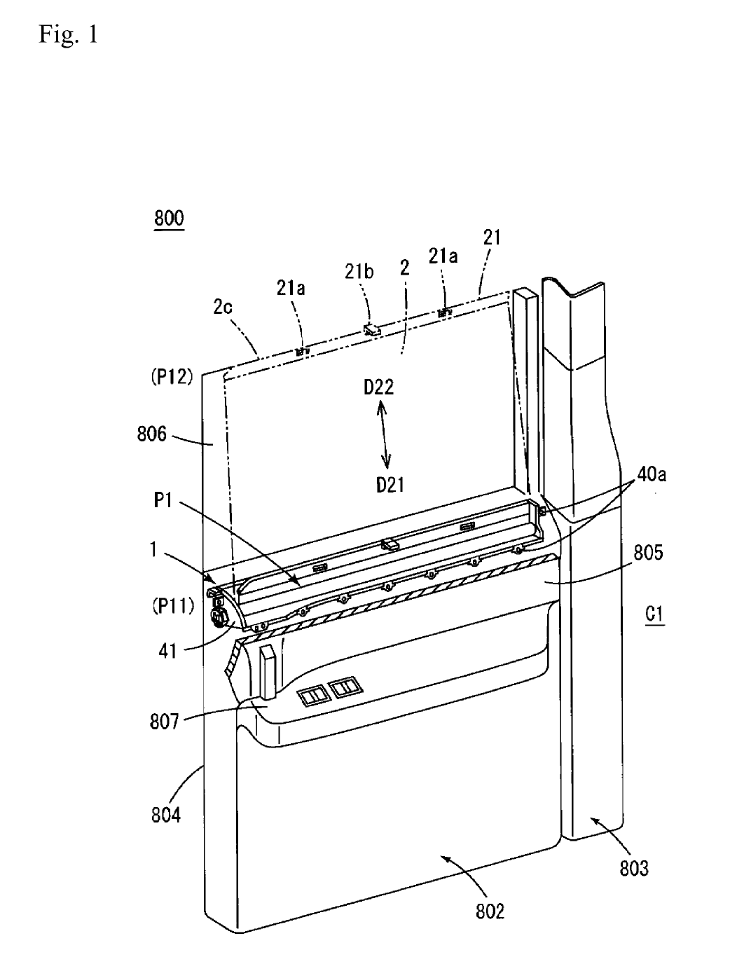

At first, an outline of the present technology will be explained with reference to FIGS. 1 to 10C.

A shading device 1 includes, as basic components, a screen 2, a shaft portion 3 to which one end of the screen 2 is fastened, a case 4 from which the screen 2 can be drawn out, a biasing mechanism 5 that biases the screen 2 toward the shaft portion (housing direction D21), and a shaft support portion 6. The case 4 has a wall portion 42 and a side face portion 46. On the wall portion 42, a hole 43 is formed so that an end portion 36 of the shaft portion 3 is inserted into the hole 43 while a clearance CL1 is formed. On the side face portion 46, an opening 47 is formed so that the shaft portion 3 is entered in a housing position P1 from a direction (D2), which is different from an axial direction D1 of the shaft portion 3 when the shaft portion 3 is located at the housing position P1. The shaft support portion 6 is inserted into the clearance CL1 formed between the hole 43 of the wall portion 42 and the end portion 36 of the shaft portion 3 to prevent the end portion 36 of the shaft portion 3 from moving in the direction (D2), which is different from the axial direction D1.

The shaft portion 3 can be entered in the housing position P1 from the opening 47 formed on the side face portion 46 of the case 4. The end portion 36 of the shaft portion 3 is inserted into the hole 43 formed on the wall portion 42 of the case 4 while the clearance CL1 is formed. Therefore, while the shaft portion 3 is inclined, the shaft portion 3 can be entered in the opening 47 and the end portion 36 of the shaft portion 3 can be inserted into the hole 43 of the wall portion 42, for example. When the shaft support portion 6 is inserted into the clearance CL1 formed between the hole 43 of the wall portion 42 and the end portion 36 of the shaft portion 3, the end portion 36 of the shaft portion 3 is prevented from moving in a direction (D2), which is different from the axial direction D1 of the shaft portion 3. Therefore, in the above described aspect, workability can be improved when assembling the shading device 1.

A second hole 62 can be formed on the shaft support portion 6 so that the end portion 36 of the shaft portion 3 is inserted into the second hole 62 while the shaft portion is separated from the wall portion 42 to prevent the end portion 36 from moving in the direction (D2), which is different from the axial direction D1. In the above described aspect, since the end portion 36 of the shaft portion 3 is not in contact with the wall portion 42, soft general-purpose resins and the like can be used for the wall portion 42. Thus, workability can be further improved when assembling the shading device 1.

A pawl portion 65 can be formed on the shaft support portion 6. The pawl portion 65 is projected toward an opposite side (outward D3 in the radial direction) of the second hole 62. When the shaft support portion 6 is inserted into the hole 43 of the wall portion 42, the pawl portion 65 is flexed toward the second hole 62 side and then engaged with the wall portion 42. A clearance CL2 can be formed between the end portion 36 of the shaft portion 3 inserted into the second hole 62 and the pawl portion 65 to allow the pawl portion 65 to be flexed. In the above described aspect, when the shaft support portion 6 is inserted into the hole 43 of the wall portion 42, the pawl portion 65 is engaged with the wall portion 42. Thus, workability is further improved when assembling the shading device 1.

An extension portion 44 can be formed on the wall portion 42. The extension portion 44 is extended outward to form the hole 43. The shaft support portion 6 can be inserted into the hole 43 formed on the extension portion 44 from an outside of the wall portion 42. In the above described aspect, the shaft support portion 6 can be inserted into the hole 43 of the wall portion 42 from the outside. Thus, workability is further improved when assembling the shading device 1.

The biasing mechanism 5 can bias the shaft portion 3 toward a winding direction DR1 of the screen 2. The end portion 36 of the shaft portion 3 can be rotatable around an axial center AX1 of the shaft portion 3 when the shaft support portion 6 is inserted into the hole 43 of the wall portion 42. In the above described aspect, workability can be improved when assembling the winding type shading device 1.

A material of the shaft support portion 6 can be harder than a material of the case 4. In the above described aspect, durability of the shading device 1 can be improved.

### (2) FIRST EXAMPLE

FIG. 1 shows the first example to use the shading device 1 for vehicle as a sunshade device of a side door (802) of an automobile 800. In the figure, the shading device 1 is shown by breaking away an upper portion of the door trim 805. The automobile 800 shown in FIG. 1 is a road running vehicle designed and equipped for being used on a road. In addition, a vehicle cabin C1 is formed around front sheets and rear sheets so that the automobile 800 can be used as a passenger car. A door 802 and a pillar 803 are arranged at a side face portion of the vehicle cabin C1. The shading device 1 is assembled with the door 802 as a sunshade device. The shading device includes the devices called a shade device and a blind device. The shading device 1 shown in FIG. 1 is installed inside an upper edge of the door trim 805 as an interior material of the side door and is a winding device capable of drawing out the screen 2.

A door panel 804, a door trim 805 and a door window 806 are provided on the door 802, for example. The door panel 804 is a kind of a vehicle body panel made of metal such as a steel sheet. The door trim 805 is an interior material attached to the vehicle cabin side of the door panel 804. For the door trim 805, a molded article formed by molding a resin molding material such as a thermoplastic resin by using injection molding or the like, and a resin material in which a skin material, such as a non-woven fabric, a woven fabric and a knitted fabric, is laminated as an interior base material can be used, for example. On the door trim 805 shown in FIG. 1, an armrest 807 having a shape enabling a passenger to rest his/her arms for maintaining a comfortable posture is provided. The shading device 1 is assembled on a back side of the door trim 805 at a position upper than the armrest 807.

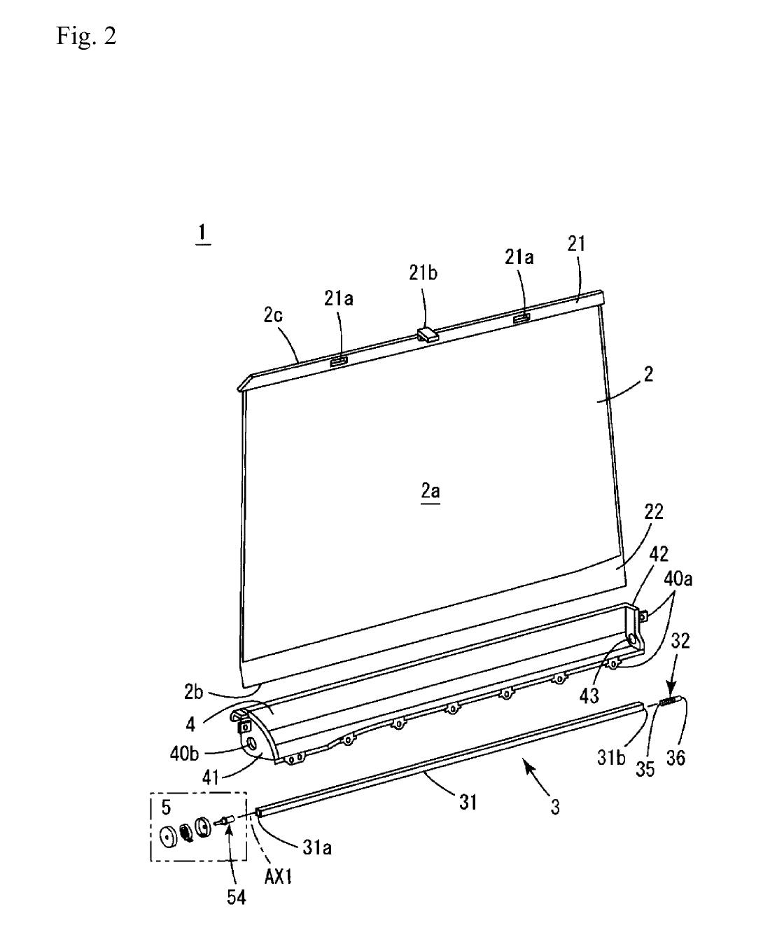

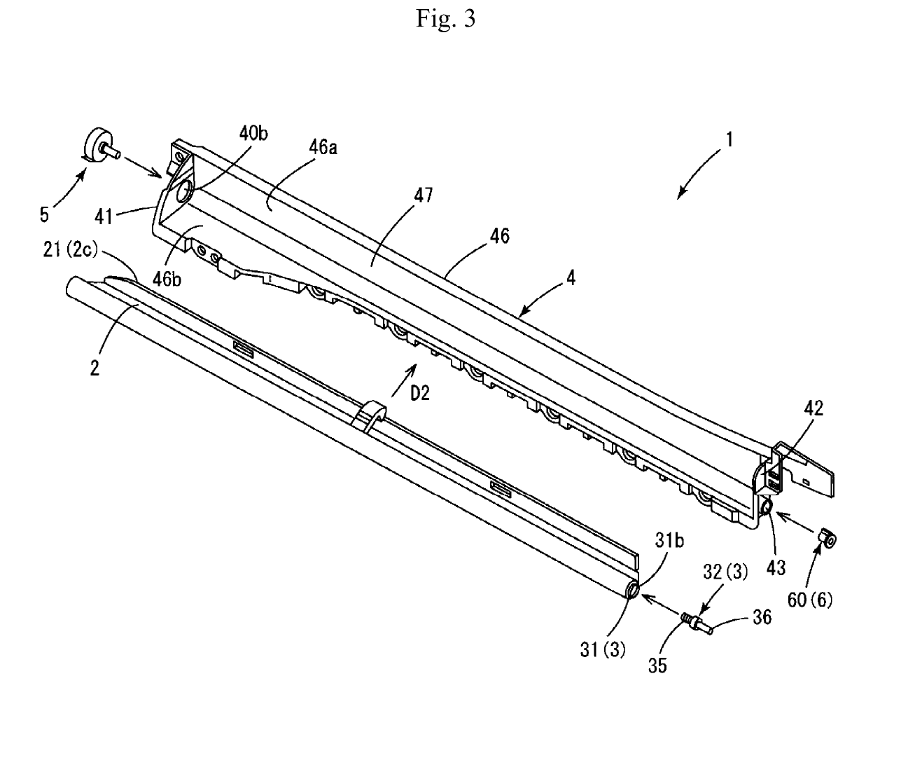

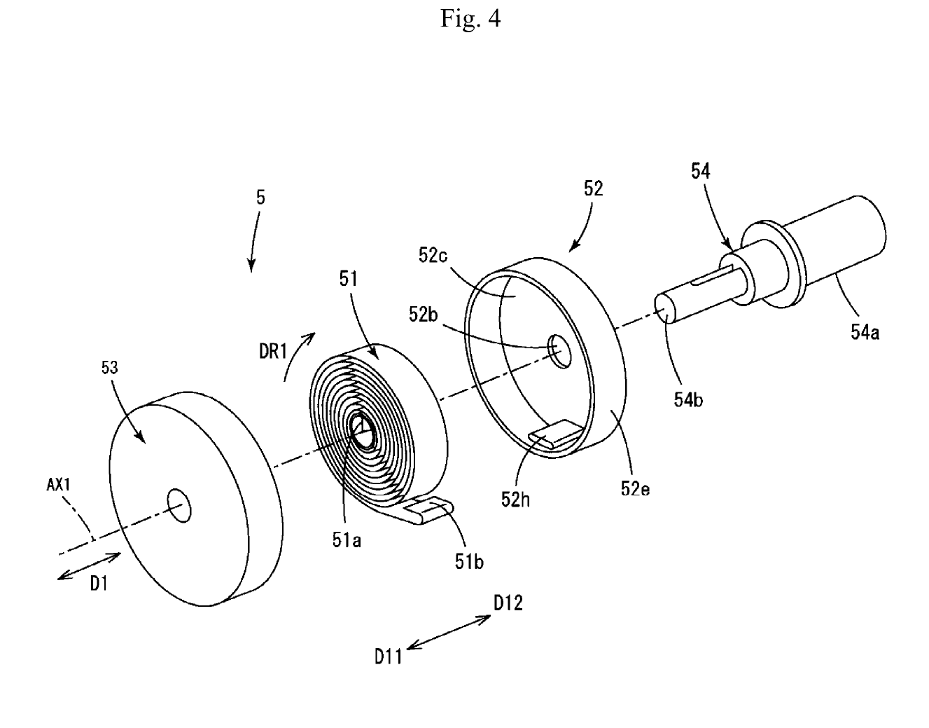

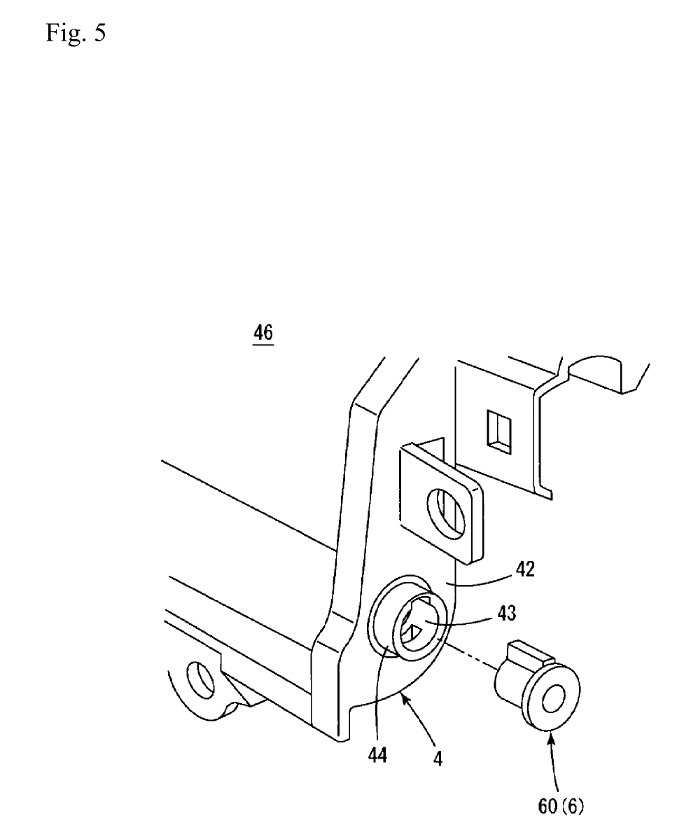

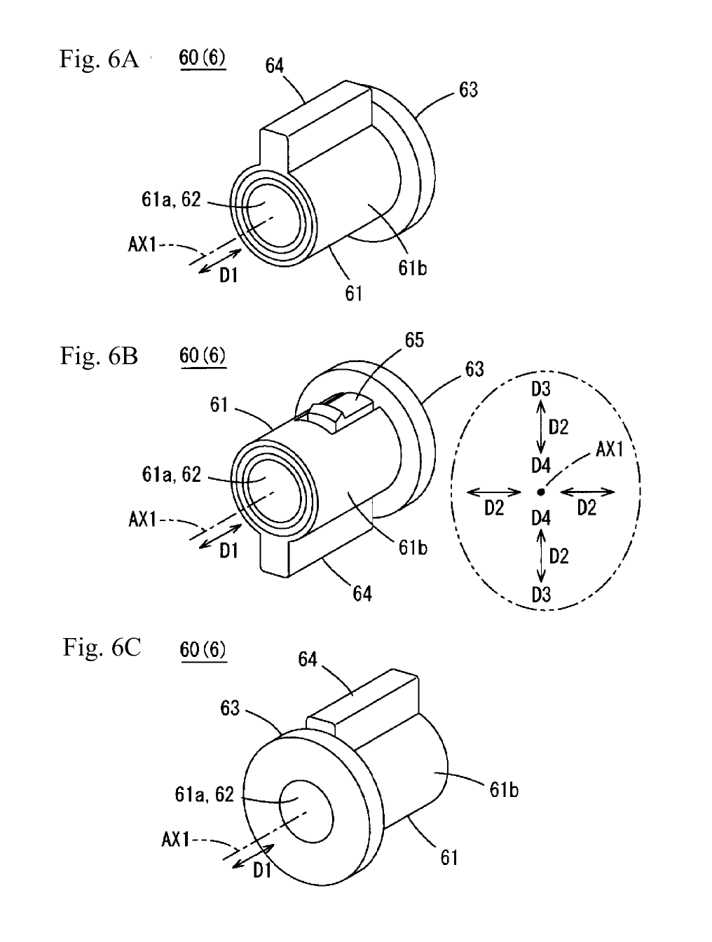

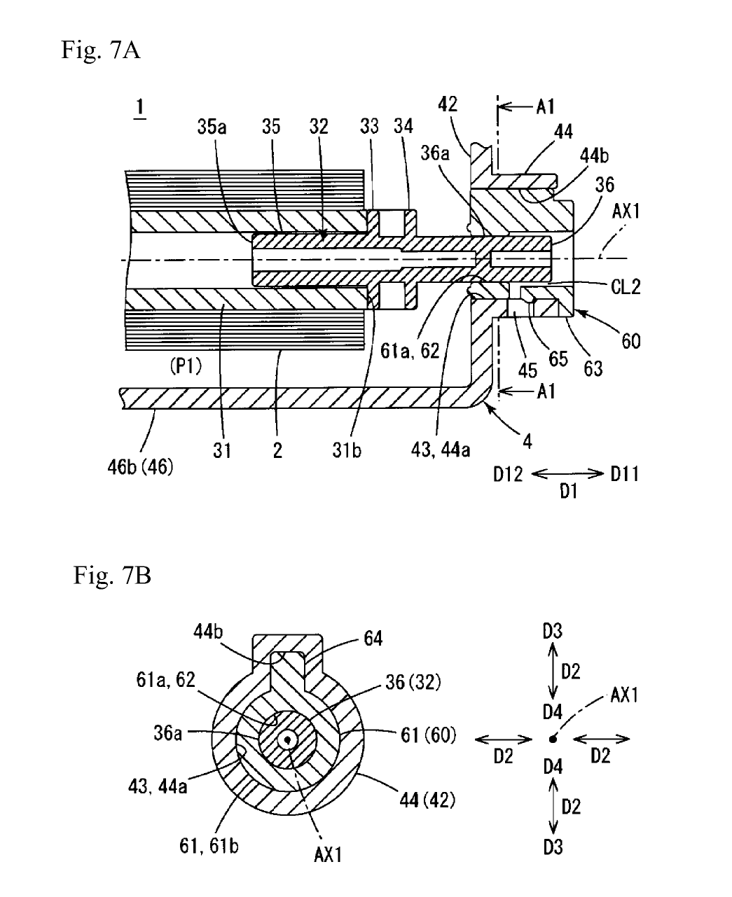

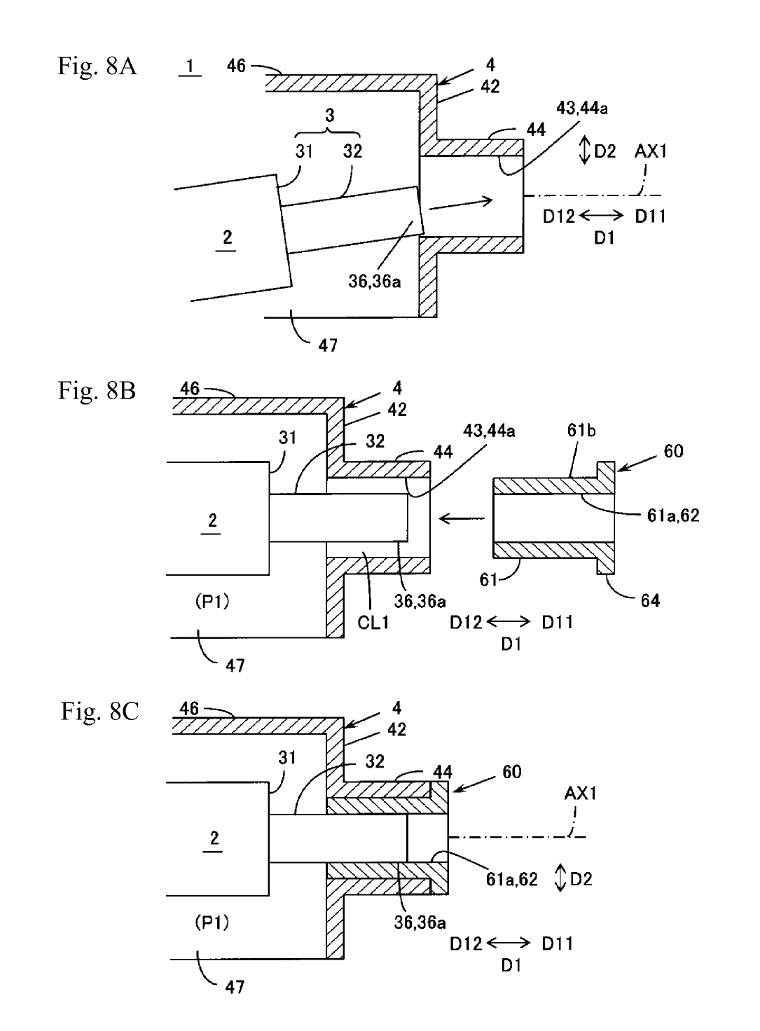

In FIG. 1, the shading device 1 in which the screen 2 is wound (housed) around a winding shaft 31 is shown by a solid line, and a state that the screen 2 is drawn out upward is shown by a two-dot chain line. FIG. 2 shows components of the shading device 1 in a disassembled state. FIG. 3 shows components of the shading device 1 in a disassembled state from another angle. FIG. 4 shows components of the biasing mechanism 5 in a disassembled state. FIG. 5 shows the wall portion 42 of the case and its surroundings. FIGS. 6A to 6C show an outer appearance of a cap 60 (shaft support portion 6). Each of the figures is viewed from different positions. FIG. 7A is a vertical cross-section showing a main part of the shading device 1 in a vertical plane passing thorough the axial center AX1. FIG. 7B is a cross section showing a main part of the shading device 1 cut along A1-A1 in FIG. 7A. FIGS. 8A to 8C schematically show an assembling method of the shading device 1.

Note that a reference numeral D11 indicates an outside direction of the axial center AX1 of the shaft portion 3, a reference numeral D12 indicates an inside direction of the axial center AX1, a reference numeral D21 indicates a housing direction of the screen 2, and a reference numeral D22 indicates a drawing direction of the screen 2.

The screen 2 is also called as a blind sheet. The screen 2 blocks at least a part of transmitted light. A body portion 2a of the screen 2 is made of sheet-like material having flexibility to be drawn out from a predetermined winding position P11 to a predetermined drawing position P12. The body portion 2a can be wound from the drawing position P12 to the winding position P11. The body portion 2a of the screen can be fibers such as polyester woven fabric, leather using resin material, a sheet formed by molding resin molding material and the like. A translucent sheet and a transparent sheet capable of blocking ultraviolet rays can be also used. The transmitted light includes ultraviolet rays and the like. The body portion of the screen for the sunshade device is formed, for example, by cutting a soft material having a light-shielding property of approximately 50 to 90% and having flexibility into a predetermined shape. The body portion is drawn out upward from the half case 4 and covers a vehicle door window from inside the vehicle cabin. The shading device 1 blocks sunlight to protect occupants from dazzling, and reduces visibility from outside the vehicle for protecting privacy and protecting against crime during parking.

A double-sided tape 22 is stuck to the one end 2b of the screen 2 shown in FIG. 2. The one end 2b of the screen is adhered to an external surface of the winding shaft 31 by winding the winding shaft 31 on an area to which the double-sided tape 22 is stuck.

A garnish member 21, which is harder than the body portion 2a, is attached to a tip edge (the other end 2c) of the screen 2. For the garnish member 21, a plate-like member, a rod-like member and a cylindrical member can be used, for example. In addition, a molded article such as an injection molded article of synthetic resin can be also used, for example. For the synthetic resin, thermoplastics resins such as polycarbonate (PC), acrylonitrile-butadiene-styrene copolymer (ABS), polypropylene (PP), a composite material of the above materials, and a material formed by adding additives to the above materials can be used, for example. The garnish member can be formed by preparing an inner component and an outer component and then sandwiching the tip edge of the screen by the both components to be engaged and integrated with each other.

Engagement holes 21a, 21a are provided on the garnish member 21 so as to be hooked on hooks of the door side. When the screen 2 is drawn out, the drawn-out state of the screen 2 can be maintained by hooking the engagement holes 21a on the hooks.

In addition, a not illustrated pipe member is provided on the garnish member 21, and a lever member 21b, which is supported by the pipe member so that the lever member 21b is rotatable around the pipe member, is provided. A user can easily draw out the screen 2 from the half case 4 by pinching the rotatable lever member 21b. For the lever member 21b, resin molded articles such as injection molded article of thermopolyolefin (TPO) can be used, for example.

The shaft portion 3 of the shading device 1 shown in FIGS. 2, 3 and other figures, includes a winding shaft 31 and a shaft member 32. The winding shaft 31 is housed in the half case 4 so that the winding shaft 31 is rotatable around the axial center AX1, which is the axial center of the shaft portion 3 when the shaft portion 3 is located at the housing position P1. The one end 2b of the screen 2 is fastened to the winding shaft 31. The winding shaft 31 can have a tubular shape such as a cylindrical shape or a bar shape such as a columnar shape. A shaft member 54 of the biasing mechanism 5 is assembled with one end 31a of the winding shaft 31. The shaft member 54 passes through a through hole 40b located at the biasing mechanism 5 side of a wall portion 41 of the half case 4. The biasing mechanism 5 attached to the one end 31a of the winding shaft 31 is an external spring unit using a spiral spring (spring 51). The shaft member 32 is assembled with the other end 31b of the winding shaft 31.

For the material of the winding shaft 31, metals such as aluminum and synthetic resins such as thermoplastic resin can be used, for example. If a pipe material formed by extruding aluminum in a tubular shape is used as the winding shaft 31, the winding shaft 31 can be easily lightweight and strong enough. A size of the tubular winding shaft made of aluminum is not particularly limited. For example, an inner diameter can be approximately 4 to 20 mm and an outer diameter can be approximately 6 to 30 mm.

The shaft member 32 shown in FIG. 7A and other figures is formed in an approximately cylindrical shape having flange portions 33, 34. The flange portions 33, 34 have a large diameter and separated with each other. A fitting portion 35, which is located at an inner side of the shaft member 32 and located from the first flange portion 33 to a fitting end 35a, is inserted into the other end 31b of the tubular winding shaft 31, for example. An outer peripheral surface 36a of the end portion 36, which is an outer side of the shaft member 32 than the second flange portion 34, is fit with an inner peripheral surface 61a of a body portion 61 of the cap with some margin, for example, so that the shaft member 32 is rotatable around the axial center AX1. The end portion 36 of the shaft member is inserted into a through hole 43 of the wall portion 42 of the case, and inserted into a second through hole 62 of the cap 60 (shaft support portion 6). The end portion 36 is the end portion of the shaft portion 3. The end portion 36 is supported by the wall portion 42 of the case via the cap 60 so that the end portion 36 is rotatable around the axial center AX1.

For the shaft members 32, 54, a molded article such as an injection molded article of synthetic resin can be used, for example. For the synthetic resin, thermoplastics resins such as polybutylene terephthalate (PBT) containing a reinforcing fiber can be used, for example. For the reinforcing fiber, a glass fiber can be used, for example. A compounding ratio of the reinforcing fiber can be approximately 5 to 30 wt. %, for example.

The half case 4 shown in FIG. 3 and other figures has a pair of wall portions 41, 42 and a side face portion 46. The wall portions 41, 42 are formed at both ends in the axial direction D1 of the shaft portion 3 when the shaft portion 3 is located at the housing position P1. An opening 47 is formed on the side face portion 46. As “side face” can mean faces other than the bottom face of a rectangular column and a cylindrical column, the side face portion 46 of the case 4 means a portion of surrounding the shaft portion 3 when the shaft portion 3 is located at the housing position P1. Therefore, the side face portion 46 includes a back portion 46a, which is a portion arranged in a longitudinal direction viewed from a user as shown in FIG. 3, and a bottom portion 46b, which is arranged in a vertical direction as shown in FIG. 3.

The wall portions 41, 42, which are facing each other in a longitudinal direction (axial direction D1) of the case 4, are formed in a vertical wall shape approximately orthogonal to the longitudinal direction (axial direction D1) of the case 4. The through hole 40b is formed on the wall portion 41, which is located at the biasing mechanism 5 side, so as to insert the shaft member 54 of the biasing mechanism 5 in a rotatable state. The hole 43 is formed on the wall portion 42, which is located at the shaft member 32 side, so as to insert the end portion 36 of the shaft portion 3 while the clearance CL1 (shown in FIG. 8B) is formed. The wall portion 42 includes the extension portion 44 which extends in an outside direction D11. The hole 43 is formed on the extension portion 44. An inner peripheral surface 44a of the extension portion 44 is fit with an outer peripheral surface 61b of the body portion 61 of the cap with some margin, for example, so that the body portion 61 of the cap can be inserted into the inner peripheral surface 44a. A positioning recess 44b, which has a shape corresponding with a positioning protrusion 64 of the cap 60, is formed on the inner peripheral surface 44a. An engagement hole 45 is formed on the extension portion 44 at a portion opposite to the positioning recess 44b so that the pawl portion 65 of the cap 60 is engaged with the engagement hole 45. The side face portion 46 is formed in an approximately L-shaped cross-section so that the back portion 46a and the bottom portion 46b are orthogonal to each other. A diameter of the opening 47 formed on the side face portion 46 is larger than the maximum diameter of the shaft portion 3. Therefore, the shaft portion 3 can be entered in the housing position P1 from a direction (radial direction D2), which is a direction different from the axial direction D1 of the shaft portion 3 when the shaft portion 3 is located at the housing position P1. The opening 47 is also used as a portion from which the screen 2 is drawn out.

The half case 4 is aligned with a recessed portion formed on the door trim side. Thus, a housing space of the winding shaft 31, the screen 2 and the like is formed. The half case 4 is a half-split body forming a part of the housing of the shading device 1. The half case 4 is unitized by being preliminarily assembled with the components such as the screen 2. Thus, only by assembling the half case 4 with the door trim, the shading device 1 is assembled with the door.

The shading device 1 is shipped in a state that the components such as the screen 2 are preliminarily assembled with the half case 4. In an assembling process of the door trim, the half case 4 is fastened to the vehicle body by inserting conventionally known fastening means such as screws into a plurality of through holes 40a formed on the half case 4. Thus, the shading device 1 is integrated with the vehicle body.

For the case 4, a molded article such as an injection molded article of synthetic resin can be used, for example. Since the cap 60 is inserted into the clearance formed between the hole 43 of the wall portion 42 and the end portion 36 of the shaft portion 3, general-purpose resins, which are lightweight and cheap, can be used for the case. For the general-purpose resins, polypropylene (PP), polyethylene (PE), polystyrene (PS), acrylonitrile-butadiene-styrene copolymer (ABS), polyvinyl chloride (PVC), polymethylmethacrylate (acrylic; PMMA), a composite material of the above materials, and a material formed by adding additives to the above materials can be used, for example.

The biasing mechanism 5 shown in FIG. 4 has a spring 51, spring cases 52, 53 and a shaft member 54. The spring 51 is housed in a housing space formed by engaging the spring cases 52, 53. The spring 51 biases the winding shaft 31 (shaft portion 3) in the winding direction DR1 of the screen 2 via the shaft member 54. The spring 51 shown in FIG. 4 is a spiral spring formed by spirally winding an elastic member such as a stainless material. A folded piece 51a located at an inner terminal is locked to an end portion 54b of the shaft member 54. A folded piece 51b located at an outer terminal is locked to a locking projection piece 52h of the spring case 52. Thus, the screen 2 is biased toward the shaft portion 3 (housing direction D21). Note that the winding direction DR1 can be a rotation direction shown in FIG. 4 and can be an opposite direction of the rotation direction.

The spring case 52 includes a housing recess 52c having an opening at the spring case 53 side to house the spring 51. A hole portion 52b is formed at the wall portion 41 side of the spring case 52 so that the end portion 54b of the shaft member 54 is inserted into the hole portion 52b. The locking projection piece 52h, which is used for locking the outside folded piece 51b of the spring 51, is projected from an inner surface of the housing recess 52c toward the outside direction D11. A side wall portion 52e of the spring case 52 is covered with the spring case 53. The spring case 53 is engaged with the spring case 52 and closes an opening of the spring case 52. For the spring cases 52, 53, a molded article such as an injection molded article of synthetic resin can be used, for example. The end portion 54b of the shaft member 54 is directed toward the outside direction D11 of the axial center AX1 and inserted into the hole portion 52b of the spring case 52. The end portion 54b receives a biasing force from the spring 51 in the rotation direction with the axial center AX1 as a center. When a fitting portion 54a of the shaft member 54 is pressed into a hole of the one end 31a of the winding shaft 31, the shaft member 54 and the winding shaft 31 are fixed with each other so as not to be relatively moved.

The cap 60 (shaft support portion 6) shown in FIGS. 6A to 6C, 7A, 7B and other figures is an independent member having an approximately cylindrical body portion 61, a large diameter flange portion 63, a positioning protrusion 64 and a pawl portion 65. The cap 60 is inserted into the hole 43 of the wall portion 42 of the case from the body portion 61 side.

The inner peripheral surface 61a of the cylindrical body portion 61 is fit with the outer peripheral surface 36a of the end portion 36 with some margin, for example, so that the end portion 36 of the shaft portion 3 is rotatable around the axial center AX1. The second hole 62 is formed so that the end portion 36 of the shaft portion 3 is inserted into the second hole 62 while the shaft portion 3 is separate from the wall portion 42, and the end portion 36 is prevented by the inner peripheral surface 61a from moving in the radial direction D2 with the axial center AX1 as a center. The radial direction D2 is a direction orthogonal to the axial direction D1 and is different from the axial direction D1. The outer peripheral surface 61b of the body portion 61 is fit with the inner peripheral surface 44a of the extension portion 44 of the wall portion with some margin, for example, so that the body portion 61 can be inserted into the hole 43 of the wall portion 42. The end portion 36 is prevented from moving in the radial direction D2 by the outer peripheral surface 61b.

The flange portion 63, which has a larger diameter than that of the body portion 61, functions as a stopper to be in contact with the extension portion 44 when the body portion 61 is inserted into the hole 43. The positioning protrusion 64 is extended outward D3 in the radial direction from the outer peripheral surface 61b so that the longitudinal direction of the positioning protrusion 64 is directed toward the axial center (AX1) of the body portion 61. The positioning protrusion 64 is inserted into the positioning recess 44b of the extension portion 44 of the wall portion. Thus, the rotation position of the cap 60 inserted into the hole 43 is determined and the pawl portion 65 is inserted into the engagement hole 45 of the extension portion 44 of the wall portion. The pawl portion 65 is provided on an opposite side of the positioning protrusion 64 with respect to the axial center (AX1) of the body portion 61. The pawl portion 65 is projected outward D3, which is opposite to the second hole 62, in the radial direction. At least the pawl portion 65 has elasticity. When the cap 60 is inserted into the hole 43, the pawl portion 65 is flexed inward D4, which is the second hole 62 side, in the radial direction and then inserted into the engagement hole 45 to be engaged with the wall portion 42. As shown in FIG. 7A, the clearance CL2 is formed between the end portion 36 inserted into the second hole 62 and the pawl portion 65 to allow the pawl portion 65 to be flexed. Even when the case 4 is made of the general-purpose resin and dimensional variance or thermal contraction is caused because of that, sliding resistance caused when the end portion 36 of the shaft portion 3 is in contact with the pawl portion 65 is prevent from being increased since the clearance CL2 is formed.

For the cap 60, a molded article such as an injection molded article of synthetic resin can be used, for example. The cap 60 is preferred to be made of a harder material (e.g. hard resin) than the case 4 since the end portion 36 of the shaft portion 3 is inserted into the second hole 62. This is significant especially when the end portion 36 of the shaft portion 3 is rotated around the axial center AX1. A hardness of the material, in particular hardness of the synthetic resin can be compared by Rockwell hardness HR compliant with JIS K7202-2: 2001 (ISO 2039-2: 1987) (Plastics—Determination of hardness—Part 2: Rockwell hardness). In the Rockwell hardness, there are different hardness scales of M, L and R. In the same hardness scale, the material becomes harder as the Rockwell hardness becomes large. Therefore, if the cap is made of the material harder than the case, the Rockwell hardness HR of the case is relatively small and the Rockwell hardness HR of the cap is relatively large in the same hardness scale. In case the hardness scale is different, if the HR value of the first material in R hardness scale is equal to or lower than the HR value of the second value in L hardness scale, the second material is harder than the first material. If the HR value of the second material in L hardness scale is equal to or lower than the HR value of the third material in M hardness scale, the third material is harder than the second material.

In addition, an engineering plastic, which is excellent in hardness, heat-resistant stability and wear resistance, is preferred for the cap since the end portion 36 of the shaft portion 3 is inserted into the second hole 62. As the above described plastic, polybutylene terephthalate (PBT), polyacetal (POM), polycarbonate (PC), polyamide 6 (PA6), polyamide 66 (PA66), polyethylene terephthalate (PET), modified polyphenylene ether (mPPE), a composite material of the above materials, and a material formed by adding additives to the above materials can be considered as an example.

Then, an assembling method, operations and effects of the shading device 1 will be explained.

At first, as shown in FIGS. 2 and 3, an end portion (2b) of the screen 2 is adhered and fixed to an external surface of the winding shaft 31, then the screen 2 is attached to the winding shaft 31 and wound around the winding shaft 31. Then, while the screen 2 is wound around the winding shaft 31 and the biasing mechanism 5 is not attached to the one end 31a of the winding shaft 31, the fitting portion 35 of the shaft member 32 is fit into the hole of the other end 31b of the winding shaft 31 to assemble the shaft member 32 with the other end 31b of the winding shaft. At this time, since the end portion 36 of the shaft member is protruded from the other end 31b of the winding shaft, a length from the one end 31a of the winding shaft to the end portion 36 of the shaft member may be longer than a length between the wall portions 41 and 42 of the case. Therefore, when the shaft portion 3 is entered in the housing position P1 of the case 4 from the opening 47, as shown in FIG. 8A, the shaft portion 3 sometimes should be inserted from a direction, which is different from the axial center AX1 of the shaft portion 3 when the shaft portion 3 is located at the housing position P1. If the inner peripheral surface 44a of the hole 43 of the wall portion 42 of the case is consistent with the outer peripheral surface 36a of the end portion 36 of the shaft member, the end portion 36 of the shaft member cannot be inserted into the hole 43 while the direction of the shaft member is different from the axial center AX1. Since the hole 43 of the wall portion 42 shown in FIGS. 8A to 8C is formed so that the clearance CL1 is formed when the end portion 36 of the shaft member is inserted into the hole 43, the end portion 36 of the shaft member can be inserted into the hole 43 while the direction of the shaft member is different from the axial center AX1. FIG. 8B shows a state that the end portion 36 of the shaft portion 3 is entered in the opening 47 and inserted into the hole 43 of the wall portion 42, and the shaft portion 3 is located at the housing position P1. At this time, the axial center AX1 of the shaft portion 3 passes through the holes 40b, 43 of both wall portions 41, 42 and the end portion 36 is “temporarily engaged” with the hole 43 of the wall portion 42. After the end portion 36 of the shaft portion 3 is inserted into the hole 43 and the shaft portion 3 is located at the housing position P1, the shaft member 54 is inserted into the through hole 40b from an outside of the wall portion 41 of the case and the biasing mechanism 5 is attached to the one end 31a of the winding shaft 31.

If the clearance CL1 is formed, the end portion 36 of the shaft member can be moved in the radial direction D2 when nothing is inserted into the clearance CL1. In order to prevent the end portion 36 of the shaft member from moving in the radial direction D2, as shown in FIG. 8B, the body portion 61 of the cap 60 is inserted into the hole 43 formed on the extension portion 44 from an outside of the wall portion 42. By doing so, the body portion 61 of the cap is inserted into the clearance CL1, which is formed between the hole 43 of the wall portion and the end portion 36 of the shaft member, and as a result, the end portion 36 of the shaft member is inserted into the second hole 62 of the cap 60. The body portion 61 of the cap inserted into the hole 43 of the wall portion 42 is not rotated because the positioning recess 44b and the positioning protrusion 64 are provided. The end portion 36 of the shaft member inserted into the second hole 62 is rotatable around the axial center AX1. The above described state is shown in FIG. 8C.

In the lining for vehicle shown in Japanese Unexamined Patent Application Publication No. H11-245663, if the opening to load/unload the sunshade is smaller than an outer diameter of the winding shaft, it is difficult to insert a hand into the housing case and difficult to see the winding shaft or the like inserted into the housing case. Thus, workability to let the end portion of the winding shaft be supported on the cap is not good. In the door trim for vehicle shown in Japanese Unexamined Patent Application Publication No. 2003-300415, if the hole having an inner diameter consistent with an outer diameter of the shaft of the rolled shade is formed on the support arm, the shaft of the rolled shade cannot be inserted into the hole of the support arm in a state that the rolled shade is inclined against the shade cover. On the other hand, in the above described shading device 1, even if a length from the one end 31a of the winding shaft to the end portion 36 of the shaft member is longer than a length between the wall portions 41 and 42, while the shaft portion 3 is inclined, the shaft portion 3 can be entered in the opening 47 and the end portion 36 of the shaft portion 3 can be inserted into the hole 43 of the wall portion 42 to position the shaft portion 3 at the housing position P1. The end portion 36 of the shaft portion 3 is prevented from moving in the radial direction D2 by the cap 60 inserted into the clearance CL1. Therefore, the present technology can improve workability when assembling the shading device and can provide a shading device having good assembling workability.

In addition, since the end portion 36 can be entered in the opening 47 and inserted into the hole 43 to house the shaft portion 3 while the shaft portion 3 is inclined, separation distance between the wall portions 41 and 42 can be configured to be approximately same as the longitudinal length of the winding shaft 31. This is because the end portion 36 protruded from an end portion (31b) of the winding shaft 31 can be inserted into the hole 43 and therefore the end portion 36 is allowed to escape from an inner surface of the wall portion 42 to outside. Therefore, the shading device 1 of the present invention can minimize the longitudinal length of the case. Thus, the weight and cost can be reduced.

Furthermore, in the lining for vehicle shown in Japanese Unexamined Patent Application Publication No. H11-245663, when the caps having an approximately same cross-sectional area as that of the housing case are attached to both ends of the housing case, the weight and cost are increased if the caps are made of hard resin, which is excellent in hardness, heat-resistant stability and wear resistance. In addition, in the door trim for vehicle shown in Japanese Unexamined Patent Application Publication No. 2003-300415, when both ends of the shaft of the rolled shade are received by the support arm integrated with the shade cover, the support arm can be worn out due to the rotation of the shaft, and backlash, fluctuation and other malfunction can be caused due to thermal expansion or thermal contraction if the shade cover is made of the general-purpose resin. If the shade cover is made of hard resin, which is excellent in hardness, heat-resistant stability and wear resistance, the weight and cost are increased. On the other hand, in the above described shading device 1, even if the case 4 is formed of the general-purpose resin, the malfunction can be prevented by using the hard resin only for the small cap 60. Thus, weight and cost can be reduced.

Furthermore, the cap 60, which has the inner peripheral surface 61a to function as a sliding surface of the end portion 36 of the shaft portion 3, is made of the hard resin, and the clearance CL2 is formed between the end portion 36 inserted into the second hole 62 and the pawl portion 65. Therefore, in the shading device 1 of the present invention, even if dimensional variance or thermal contraction is caused because the case is made of the general-purpose resin, sliding resistance caused when the end portion 36 is in contact with the pawl portion 65 is prevent from being increased. Thus, malfunction and deterioration of operation feeling can be prevented.

### (3) SECOND EXAMPLE

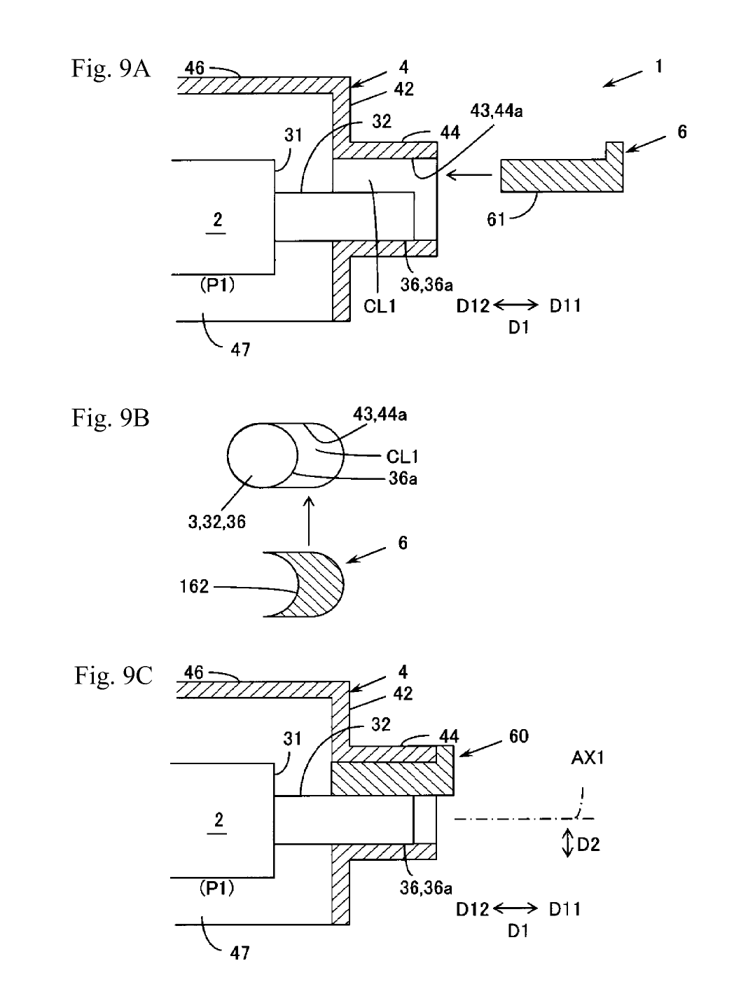

FIGS. 9A to 9C schematically show an example of a main part of another shading device 1. The shaft support portion 6 of the shading device 1 does not have the second hole, which is formed for separating the end portion 36 of the shaft portion 3 from the wall portion 42 of the case. The shaft support portion 6 has a contact surface 162, which is in contact with a part of the outer peripheral surface 36a of the end portion 36. At a part not in contact with the shaft support portion 6, the outer peripheral surface 36a is in contact with the inner peripheral surface 44a of the wall portion 42.

In this case, as shown in FIGS. 9A and 9B, the body portion 61 of the shaft support portion 6 is inserted into the hole 43 formed on the extension portion 44 from outside the wall portion 42 to prevent the end portion 36 of the shaft member from moving in the radial direction. By doing so, the body portion 61 is inserted into the clearance CL1, which is formed between the hole 43 of the wall portion and the end portion 36 of the shaft member, and as shown in FIG. 9C, the end portion 36 of the shaft member inserted into the hole 43 is rotatable around the axial center AX1 while the movement in the radial direction is prevented. Therefore, this variation example can also improve workability when assembling the shading device and can provide a shading device having good assembling workability.

### (4) THIRD EXAMPLE

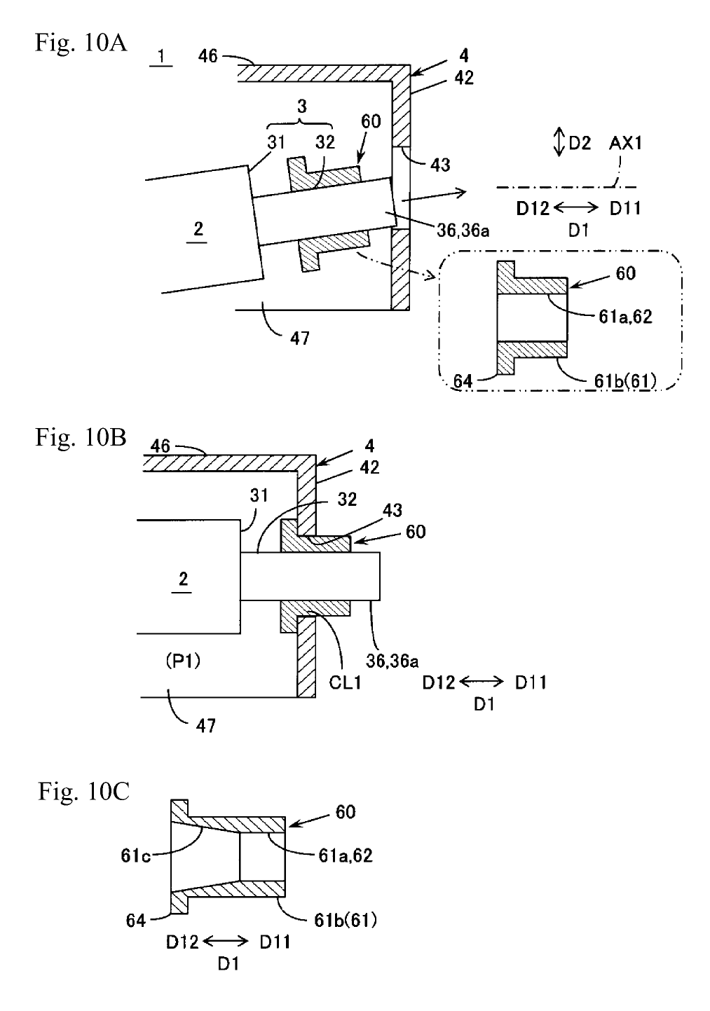

FIGS. 10A and 10B schematically show an example of a main part of another shading device 1. The cap 60 (shaft support portion 6) of the shading device 1 is inserted into the hole 43 of the wall portion 42 of the case from inside the wall portion 42. In this case, the extension portion is not necessarily formed on the wall portion 42. Since the extension portion can be removed from the wall portion 42, the longitudinal length of the case 4 can be shortened.

In this case, the end portion 36 of the shaft member 32 is inserted into the second hole 62 of the cap 60 and the end portion 36 is protruded from the body portion 61, then the end portion 36 is inserted into the hole 43 of the wall portion 42 so that the clearance CL1 is formed. By doing so, even if the length from the one end 31a of the winding shaft to the end portion 36 of the shaft member is longer than the length between the wall portions 41 and 42, the end portion 36 can be inserted into the hole 43 while the direction of the shaft member is different from the axial center AX1. When the end portion 36 of the shaft member is inserted into the second hole 62 of the cap 60 and the cap 60 is inserted into the clearance CL1 formed between the hole 43 of the wall portion and the end portion 36 of the shaft member, the shaft portion 3 is positioned at the housing position P1 while the end portion 36 of the shaft member is prevented from moving in the radial direction D2. After that, the biasing mechanism 5 is attached to the one end 31a of the winding shaft 31. Thus, the shading device 1 can be assembled. Therefore, this variation example can also improve workability when assembling the shading device and can provide a shading device having good assembling workability.

From the above, the present invention has an aspect of a method of assembling a shading device, the shading device comprising: a screen; a shaft portion to which one end of the screen is fastened; a case from which the screen can be drawn out; and

a biasing mechanism that biases the screen toward the shaft portion, wherein

a wall portion and a side face portion are formed on the case, a hole is formed on the wall portion so that an end portion of the shaft portion is inserted into the hole while a clearance is formed, an opening is formed on the side face portion so that the shaft portion is entered in a housing position from a direction, which is different from an axial direction of the shaft portion when the shaft portion is located at the housing position,

the end portion of the shaft portion is entered in the opening and inserted into the hole of the wall portion to position the shaft portion at the housing position, and

a shaft support portion is inserted into the clearance formed between the hole of the wall portion and the end portion of the shaft portion to prevent the end portion of the shaft portion from moving in the direction different from the axial direction.

Note that, as exemplified in FIG. 10C, the inner peripheral surface 61a of the cap 60 can be divided into two parts: one is a part arranged on the outside direction D11 side to be fit with the outer peripheral surface 36a of the end portion 36 of the shaft member, and the other is a part 61c arranged on the inside direction D12 side to form a clearance between the inner peripheral surface 61a and the outer peripheral surface 36a. By doing so, after the cap 60 is inserted into the hole 43 of the wall portion 42 from inside the wall portion 42, when the end portion 36 of the shaft member is inserted into the second hole 62 of the cap 60, the end portion 36 can be inserted into the second hole 62 while the direction of the shaft member is different from the axial center AX1. Therefore, this variation example can also improve workability when assembling the shading device and can provide a shading device having good assembling workability.

### (5) OTHER VARIATION EXAMPLES

Various variation examples can be considered for the present invention.

The shading device as the sunshade device can be installed on a rear window, a roof window and a front window, for example, without limited to a side window. The shading device can be a tonneau cover device, for example. A direction of drawing the screen can be downward and horizontally, for example, without limited to upward.

In addition, the shading device can house the screen in bellows, without limited to a type of winding the screen.

The end portion of the shaft portion can be a portion to be rotated around the axial center or a portion not to be rotated. For example, if the winding shaft is connected to the shaft member to be rotatable around the axial center, the shaft member, and furthermore the end portion of the shaft portion, do not have to be rotatable.

The shaft portion can be a single member such as a rod-like member having the end portion to be inserted into the hole of the wall portion, without limited to a combination of the winding shaft and the shaft member.

The biasing mechanism can be a helical spring (coil spring) or an elastic member formed of elastomer, for example, without limited to the spiral spring.

A cross-section of the shaft support portion can be an approximately polygonal cylindrical shape such as an approximately octagonal cylindrical shape, for example, without limited to an approximately cylindrical shape. An outer shape of the flange portion of the shaft support portion can also be an approximately polygonal shape such as an approximately octagonal shape, for example, without limited to an approximately circular shape.

Assembling order of the components of the shading device 1 can be arbitrarily changed. For example, the cap 60 can be inserted into the hole 43 before the biasing mechanism 5 is assembled with the one end 31a of the winding shaft 31.

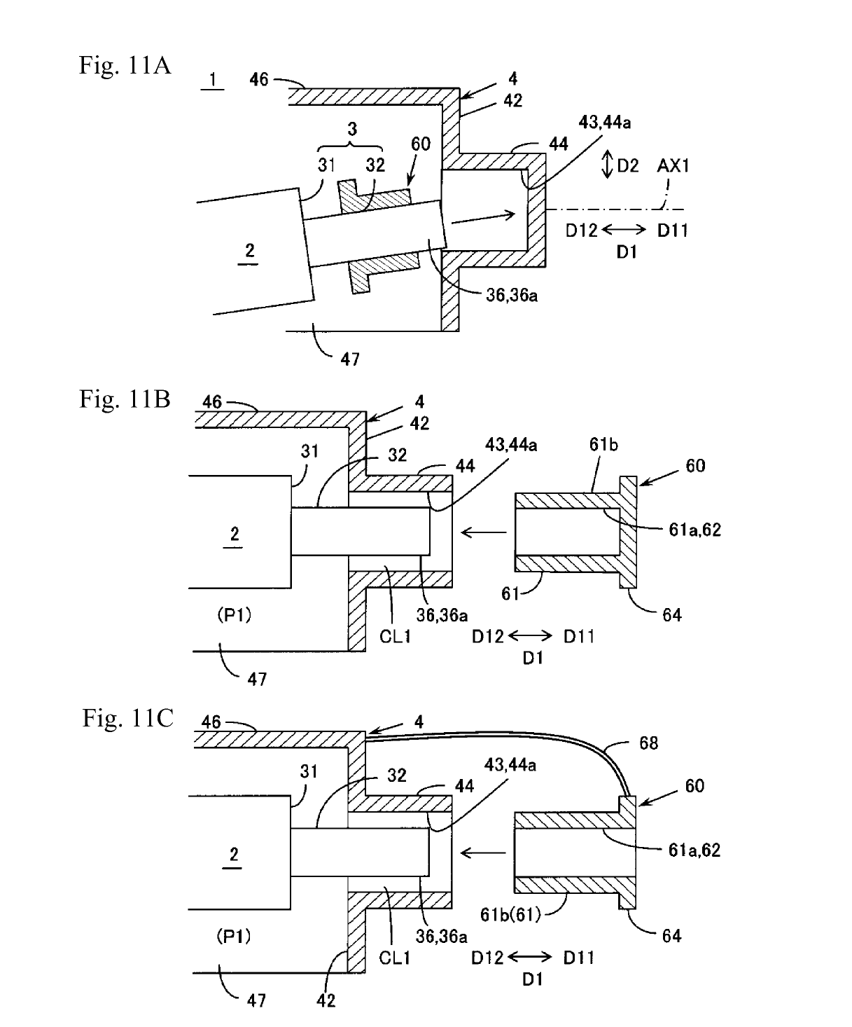

As exemplified in FIG. 11A, the hole 43 of the wall portion 42 of the case does not have to be the through hole. The hole 43 shown in FIG. 11A is a recess formed on the wall portion 42 and recessed in the outside direction D11. In this case, the cap 60 is inserted into the hole 43 of the wall portion 42 from inside the wall portion 42. In this case, foreign matter is prevented from entering in the hole 43 of the wall portion 42.

As exemplified in FIG. 11B, the second hole 62 of the cap 60 also does not have to be the through hole. The second hole 62 shown in FIG. 11B is a recess recessed from the body portion 61 side to the outside direction D11. In this case, the cap 60 is inserted into the hole 43 of the wall portion 42 from outside the wall portion 42. Also in this case, foreign matter is prevented from entering in the hole 43 of the wall portion 42.

As exemplified in FIG. 11C, the cap 60 can be a portion connected with other components, such as the case 4, of the shading device 1. The cap 60 exemplified in FIG. 11C is connected with the wall portion 42 of the case via a string 68. In this case, the cap 60 is prevented from being lost.

Note that basic effect of the present invention can be obtained even when the material of the shaft support portion 6 is not harder than the material of the case 4.

Basic effect of the present invention can be obtained even when the pawl portion 65 is not provided on the shaft support portion 6.

Basic effect of the present invention can be obtained even when the positioning protrusion 64 is not provided on the shaft support portion 6. Basic effect of the present invention can be obtained even when the positioning recess 44b is not provided on the wall portion 42 of the case.

### (6) CONCLUSION

As explained above, according to various embodiments of the present invention, a technology of improving workability when assembling the shading device can be provided. Of course, the above-described basic operation and effect can be obtained even with the components described in the independent claims (including the aspects described in the embodiments) and having no features set forth in the dependent claims.

The present invention can be also implemented by replacing the features disclosed in the above-described embodiments and variation examples with each other or changing the combinations thereof, and the present invention can be also implemented by replacing the conventional features and the features disclosed in the above-described embodiments and variation examples with each other or changing the combinations thereof. The present invention includes these features.

What is claimed is:

1. A shading device, comprising:
a screen;
a shaft portion to which one end of the screen is fastened;
a case from which the screen can be drawn out, the case including a wall portion having a hole so that an end portion of the shaft portion is inserted into the hole while a first clearance is formed, the case including a side face portion having an opening so that the shaft portion is entered in a housing position from a direction, the direction being different from an axial direction of the shaft portion when the shaft portion is located at the housing position;
a biasing mechanism that biases the screen toward the shaft portion; and
a shaft support portion that is inserted into the first clearance formed between the hole of the wall portion and the end portion of the shaft portion to prevent the end portion of the shaft portion from moving in the direction different from the axial direction.

2. The shading device according to claim 1, wherein
the shaft support portion has a second hole so that the end portion of the shaft portion is inserted into the second hole while the shaft portion is separated from the wall portion to prevent the end portion from moving in the direction different from the axial direction.

3. The shading device according to claim 2, wherein
the shaft support portion has a pawl portion that is projected toward an opposite side of the second hole,
when the shaft support portion is inserted into the hole of the wall portion, the pawl portion is flexed toward the second hole side and then engaged with the wall portion, and
a second clearance is formed between the end portion of the shaft portion inserted into the second hole and the pawl portion to allow the pawl portion to be flexed.

4. The shading device according to claim 1, wherein
the wall portion has an extension portion that is extended outward to form the hole, and
the shaft support portion is inserted into the hole formed on the extension portion from an outside of the wall portion.

5. The shading device according to claim 1, wherein
the biasing mechanism biases the shaft portion toward a winding direction of the screen, and
the end portion of the shaft portion is rotatable around an axial center of the shaft portion when the shaft support portion is inserted into the hole of the wall portion.

6. The shading device according to claim 1, wherein
a material of the shaft support portion is harder than a material of the case.

7. A method of assembling a shading device, the shading device including a screen, a shaft portion to which one end of the screen is fastened, a case from which the screen can be drawn out, and a biasing mechanism that biases the screen toward the shaft portion, the method comprising:
forming a wall portion on the case, the wall portion having a hole so that an end portion of the shaft portion is inserted into the hole while a first clearance is formed;
forming a side face portion on the case, the side face portion having an opening so that the shaft portion is entered in a housing position from a direction, the direction being different from an axial direction of the shaft portion when the shaft portion is located at the housing position;
entering the end portion of the shaft portion in the opening to insert the shaft portion into the hole of the wall portion,
positioning the shaft portion at the housing position, and
inserting a shaft support portion into the clearance formed between the hole of the wall portion and the end portion of the shaft portion to prevent the end portion of the shaft portion from moving in the direction different from the axial direction.
